(19) United States
(12) Patent Application Publication
(10) Pub. No.: US 2016/0113311 A1
(43) Pub. Date: Apr. 28, 2016

(54) METHOD OF MANUFACTURING A FERMENTED PRODUCT

(71) Applicant: Carmen Maria Cadena-Garcia, Garden City, ID (US)

(72) Inventor: Carmen Maria Cadena-Garcia, Garden City, ID (US)

(73) Assignee: FOREVERGRAINS LLC, Garden City, ID (US)

(21) Appl. No.: 14/990,088

(22) Filed: Jan. 7, 2016

Related U.S. Application Data
(63) Continuation of application No. 14/063,317, filed on Oct. 25, 2013.
(60) Provisional application No. 61/718,889, filed on Oct. 26, 2012.

(51) Int. Cl. A23L 1/00

(52) U.S. Cl. CPC A23L 1/105; A23L 1/1033; A23V 2002/00

(57) ABSTRACT

A method of manufacturing a fermented food product, including the step of providing a rinsed whole grain mixture including whole grain sweet rice, whole grain quinoa, whole grain amaranth, and not including soy. The method includes the step of sprouting the whole grain mixture thereby forming a sprouted mixture. The method includes the step of cooking the sprouted mixture thereby forming a cooked mixture. The method includes fermenting the cooked mixture using a starter culture. The method includes the step of converting the cooked mixture into a paste.

### CROSS-REFERENCE TO RELATED APPLICATIONS

This application is a Continuation Application of, under 35 U.S.C. §121, and claims priority to, under 35 U.S.C. §121, U.S. Non-Provisional application Ser. No. 14/063,317, entitled Method of Manufacturing a Fermented Product, by Carmen Maria Cadena-Garcia, filed on Oct. 25, 2013. This invention also claims priority, under 35 U.S.C. §120, to the U.S. Provisional Patent Application No. 61/718,889 to Carmen Maria Cadena-Garcia filed on Oct. 26, 2012, which is incorporated by reference herein.

### FIELD OF THE INVENTION

The present invention relates to fermentation processes and product produced thereby, specifically a fermentation process to blend whole grains and a blended whole grain food product.

### DESCRIPTION OF THE RELATED ART

Fermentation in food processing is the conversion of carbohydrates to alcohols and carbon dioxide or organic acids using yeasts, bacteria, etc. or a combination thereof, under anaerobic conditions. Fermentation usually implies that the action of microorganisms is desirable. The science of fermentation is also known as zymology or zymurgy.

The term “fermentation” is sometimes used to specifically refer to the chemical conversion of sugars into ethanol, a process which is used to produce alcoholic beverages such as wine, beer, and cider. Fermentation also is employed in the leavening of bread (CO₂ produced by yeast activity); in preservation techniques to produce lactic acid in sour foods such as sauerkraut, dry sausages, kimchi, and yogurt; and in pickling of foods with vinegar (acetic acid).

Natural fermentation precedes human history. Since ancient times, however, humans have been controlling the fermentation process. The earliest evidence of an alcoholic beverage, made from fruit, rice, and honey, dates from 7000-6600 BCE, in the Neolithic Chinese village of Jiahu, and winemaking dates from 6000 BCE, in Georgia, in the Caucasus area. Seven-thousand-year-old jars containing the remains of wine have been excavated in the Zagros Mountains in Iran, which are now on display at the University of Pennsylvania. There is strong evidence that people were fermenting beverages in Babylon circa 3000 BC, ancient Egypt circa 3150 BC, pre-Hispanic Mexico circa 2000 BC, and Sudan circa 1500 BC.

Some improvements have been made in the field. Examples of references related to the present invention are described below in their own words, and the supporting teachings of each reference are incorporated by reference herein:

U.S. Pat. No. 7,074,441, issued to Berg et al., discloses an improved method for the production of fermented food products, and in particular fermented cereal products of tempech-type using whole grain cereals as raw material, makes it possible to achieve a product of good microbial, nutritional and sensory quality.

U.S. Pat. No. 8,034,586, issued to Broekaert et al., discloses a method for producing preparations comprising soluble arabinoxylans as co-products of ethanol production through fermentation of whole-grain cereals. The method results in preparations that are highly enriched in soluble arabinoxylans, which can be used as a food, beverage, or feed ingredients.

U.S. Patent Application Publication No. 2010/0203217, by Nair, discloses a composition comprising: a spoonable, creamy semisolid food product such as a RTE pudding containing whole grains either added as flour or slurry that has been adequately processed at high temperatures, either aseptic or UHT to ensure shelf life either at room temperature or refrigerated where the whole grain addition allows for a smooth and creamy texture product. A whole grain slurry which is processed at adequate temperatures to ensure low microbial load and may be used to incorporate whole grains in several types of foods not limited to semi solid foods such as puddings, yogurts and sauces.

U.S. Patent Application Publication No. 2010/0119681, by Yumita, discloses an invention that gives effects on maintenance and so on of physical health and can be readily ingested for a long period by anyone. The present invention comprises at least whole fish (dried sardine), seed, rock salt, olive oil, and soybean paste, to be produced in a powder form, in a paste form, or the like. It further comprises either a wheat whole grain or a rye whole grain or both to be produced as cookies. About 30 to 60 wt. % either a wheat whole grain or a rye whole grain or both, about 1 to 2 wt. % whole fish, about 8 to 28 wt. % seed, about 0.6 to 1.2 wt. % natural salt, about 5 to 12 wt. % olive oil, and about 7 to 16 wt. % soybean paste are preferably mixed. The seed preferably includes almond powder, pine nuts, walnuts, chopped almonds, and white sesame.

U.S. Patent Application Publication No. 2009/0098624, by Deinhammer et al., discloses a fermentation process for producing a fermentation product from starch-containing material wherein one or more antibacterial agents are added before and/or during fermentation.

The inventions heretofore known suffer from a number of disadvantages, including but not limited to melting; being perishable; requiring water, cooling, or heating prior to consumption; not being a complete meal; lacking critical nutrients; not being adaptive; being limited in use; being limited in presentation; not satisfying natural cravings; being limited in texture; being limited in flavor; being limited in color; having a short shelf-life; being limited in consistency; not being filling; being limited in moisture content; and the like.

What is needed is a method of manufacturing a fermented product that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available method of manufacturing a fermented product. Accordingly, the present invention has been developed to provide a method of manufacturing a fermented product with improved healthy ingredients.

According to one embodiment of the invention, there is a method of manufacturing a fermented food product. The method may include the step of providing a rinsed whole grain mixture including whole grain sweet rice, whole grain quinoa, whole grain amaranth, and not including soy. The rinsed whole grain mixture may include a whole grain selected from the group of whole grains including: barley, oats, millet, buckwheat, rye, teff, and kamut The method may include the step of sprouting the whole grain mixture thereby forming a sprouted mixture. The method of manufacturing a fermented product may include the step of cooking the sprouted mixture (or an un-sprouted mixture) thereby forming a cooked mixture. The method may also include fermenting the cooked mixture using a starter culture. The method may include the step of converting the cooked mixture into a paste.

The method of manufacturing a fermented product may include the step of soaking the whole grain mixture. The method may include the step of adding water and sweetener to the fermented cooked mixture. The method may include blending the fermented cooked mixture with oils and fats. The method may include the step of cooling or draining the blended grain mixture. The method may also include the step of adding a food selected from the group of foods consisting of: seaweeds, micro-alga, and teff. The method may include the step of not adding non-food chemicals, non-natural chemicals, dairy, gluten, and GMO foods and wherein the fermented food product does not include the same. The method of manufacturing a fermented product may include the step of processing the paste according to a process selected from the group of processes consisting of drying and freezing. The method may include the step of blending the paste with a fat.

According to one embodiment of the invention, there is a blended food product comprising fermented whole grain sweet rice sprouts, fermented whole grain quinoa sprouts, and fermented whole grain amaranth sprouts. The product may not include soy. The product may not include dairy and not including gluten. The product may be dry and powdered. The product may include a fermented whole grain sprout selected from the group of whole grain sprouts including: barley, oats, millet, buckwheat, rye, teff, and kamut. The product may include water, sweetener, and fat. The food product may include between about 30% and about 70% sprouts. The rice sprouts, quinoa sprouts, and amaranth sprouts may be present in substantially equal proportions.

According to one embodiment of the invention, there is a blended food product that may include fermented whole grain sweet rice sprouts; fermented whole grain quinoa sprouts; fermented whole grain amaranth sprouts; a fermented whole grain sprout selected from the group of whole grain sprouts including: barley, oats, millet, buckwheat, rye, teff, and kamut; water; sweetener; and fat, while not including soy, not including gluten and not including dairy.

According to one embodiment of the invention, there is a method of manufacturing a fermented food product. The method may include the step of providing a rinsed whole grain mixture including whole grain sweet rice; whole grain quinoa; whole grain amaranth; a whole grain selected from the group of whole grains including: barley, oats, millet, buckwheat, rye, teff, and kamut; and not including soy, dairy and gluten.

The method of manufacturing a fermented product may include the step of soaking and draining the whole grain mixture until the whole grain mixture sprouts thereby forming a sprouted mixture.

The method may include the step of cooking the mixture, sprouted or non-sprouted or a combination thereof, thereby forming a cooked mixture. The method of manufacturing a fermented product may include the step of fermenting the cooked mixture using a starter culture. The method may also include the step of adding water and sweetener to the fermented cooked mixture. The method may include the step of blending the fermented cooked mixture with a fat. The method may further include the step of adding a food selected from the group of foods consisting of: seaweeds, micro-alga, and teff. The method of manufacturing a fermented product may include the step of converting the cooked mixture into a paste.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a flowchart of a method of manufacturing a fermented product, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of and “consisting essentially of.”

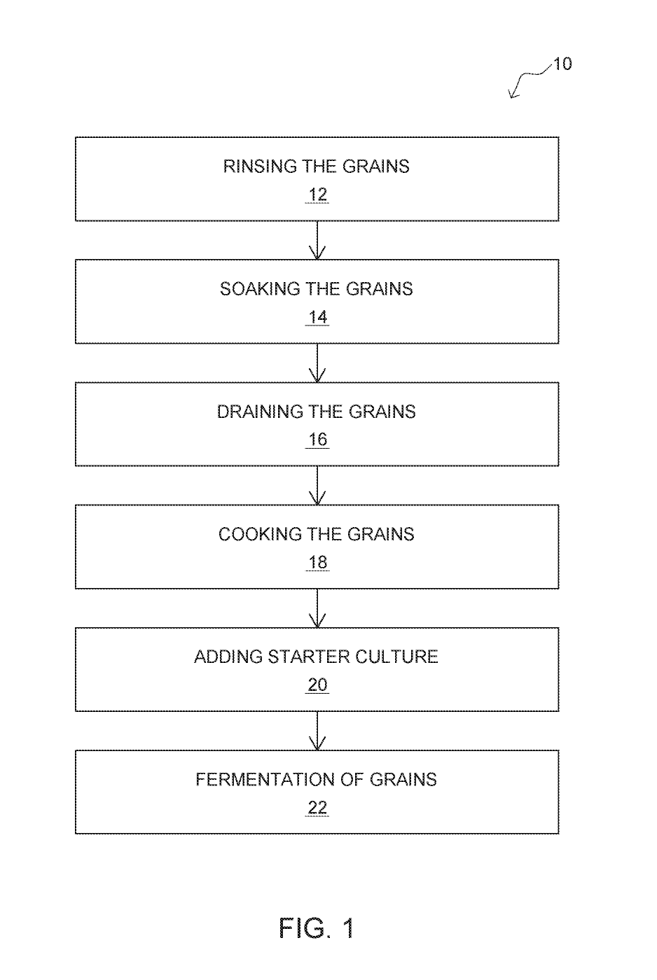

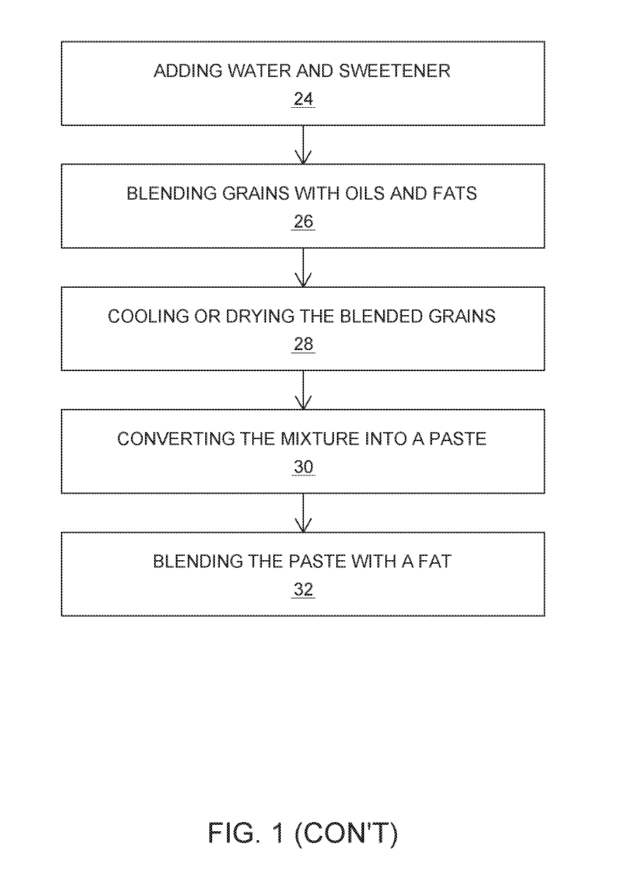

FIG. 1 is a flowchart of a method of manufacture of blended whole grains, according to one embodiment of the invention. There is shown a method of manufacturing a fermented product. In particular, there is shown a method for converting grains to a food product having enhanced nutritional, storage, aesthetic, utilization, and other properties for use by humans 10.

The illustrated method of manufacturing a fermented food product 10 to provide a food product having enhanced nutritional, storage, aesthetic, utilization, and other properties for use by humans. The method of manufacturing a fermented product 10 includes the step of rinsing and/or providing a rinsed whole grain mixture including whole grain sweet rice, whole grain quinoa, whole grain amaranth, and not including soy 12. The whole grain mixture may include only grains that have no gluten and that have been cultivated in a manner to prevent cross-contamination by grains having gluten. The rinsed whole grain mixture may also include one or more portions of whole grain(s) selected from the group of whole grains including: barley, oats, millet, buckwheat, rye, teff, and kamut. The grains may be rinsed with water to remove particulate materials (husks, sand, etc.), clean the grains, remove traces of undesired materials and the like. The grains may be rinsed by a fluid including additives that enhance the rinsing process by altering surface tension of water and/or other properties of the fluid such that the rinsing process may be more quickly and/or effectively accomplished. It is generally desired that the rinsing process not destroy beneficial bacteria and not leave a residue that would badly influence taste or nutrition.

The illustrated method of manufacturing a fermented product 10 includes the step of sprouting some, all or none of the whole grain mixture thereby forming a sprouted mixture 14. The step of sprouting the whole grain mixture includes soaking an appropriate portion of the whole grain mixture (or soaking sets of grains separately, such as but not limited to wherein different grains require different soaking characteristics) in water and draining the whole grain mixture, from the water, once the whole grain mixture has been soaked sufficiently to begin the sprouting process. Generally, grains will be soaked for several hours but not so long that sprouting is inhibited. For most grains, the grains will be drained after soaking but still kept moist to prevent dehydration, such as but not limited to being stored in a moist container (cloth, soil, etc.), soaked for short periods, misted, etc. so that the sprouting will continue. Gelatinous grains/seeds (flax, chia, etc.) may skip the initial soaking Rinse and drain cycles may be used to provide grains with additional water during the sprouting process. Generally, the sprouting grains are not left for significant periods of time immersed in water, except for the initial soak. Further, other sprouting conditions (light conditions, temperature, soaking/rinsing cycles, etc.) may be set during the sprouting process to optimize the sprouting step and may vary based on specific whole grain mixes. Generally, sprouting is done out of direct sunlight, but not in the dark. Sprouting may take several days depending on how developed one desires the sprouts to be before cooking the sprouts. Sprouting advantageously converts stored energy within the grains into additional nutrients.

The illustrated method of manufacturing a fermented product 10 includes the step of cooking the mixture (sprouted, un-sprouted, or partially sprouted) thereby forming a cooked mixture 18. The sprouted mixture may be heated to temperatures sufficient to alter the structure thereof but will generally be cooked at a temperature that is not so high that beneficial bacteria are destroyed. Cooking times and temperatures may vary based on the whole grain mix and characteristics of the sprouted mixture. Wherein a pure inoculation is desired during the fermentation step, the mixture may be cooked at higher temperatures (˜350 degrees Fahrenheit or even higher) in order to sterilize the mixture.

The illustrated method of manufacturing a fermented product 10 includes the step of fermenting the cooked mixture using a starter culture 20. A predetermined culture of probiotics may be added and/or mixed into the cooked mixture and then allowed to ferment. Generally, cultures that break down difficult to digest materials (gluten, lectin, phytic acid, etc.) are utilized during this step, thereby further enhancing the bioavailability of nutrients therein. Cultures may include Lactobacillus, Leuconostoc, yeasts, molds, fungi, etc.

The illustrated method of manufacturing a fermented product 10 includes the step of converting the cooked mixture into a paste 30. This is generally accomplished by grinding, crushing, smashing, pulping, or otherwise mechanically reducing the particle size of the mixture to very small average sizes so that the material has a paste-like consistency. Various machines and/or devices may be utilized in this step, including but not limited to mills, pulpers, paste making machines, etc. which generally include an intake funnel/reservoir, a fluid feed for adding additional liquid (water, oils, sweeteners, etc.) as desired for consistency and/or other desired characteristics, and a grinder (usually rotary) facing a mesh having a screen size of the desired average particle size. Accordingly, the cooked fermented mixture may be fed into the device and a paste may be extracted therefrom opposite the mesh.

The method 10 includes the step of adding water and sweetener to the fermented cooked mixture 24. This may be accomplished simultaneously with the paste making stage and/or before and after the same and/or may be distributed in time about the paste making stage. There may be ingredients that are optimally added before and/or during pasting that may facilitate the pasting process. Sweeteners may include sugar, brown sugar, honey, stevia, fructose, sucrose, lactose, etc.

The illustrated method of manufacturing a fermented product includes the step of blending the fermented cooked mixture with oils and fats 26. This may be accomplished simultaneously with the paste making stage and/or before and after the same and/or may be distributed in time about the paste making stage. There may be ingredients that are optimally added before and/or during pasting that may facilitate the pasting process. Oils/fats may include flax oil, olive oil, vegetable oils, canola oil, sunflower oil, peanut oil, sesame oil, avocados, nuts (peanuts, macadamia nuts, hazelnuts, pecans, almonds, walnuts, etc.), fish oils, tofu, corn oil, butter, cheese, coconut oil, etc.

The illustrated method of manufacturing a fermented product includes the step of cooling or drying/draining the blended grain mixture 28. The material may be simply left in open air (generally spread out to have a high surface area) and/or may be dried/cooled through operation of machinery (blowers, refrigeration units, heat exchangers, etc.) and/or by proximity to moisture absorbing materials (dry rice, etc.). The cooling/drying may result in a caked and/or powdered material that may then be dry packed and/or shipped with a substantially reduced weight. The material may be reconstituted later before consumption.

The illustrated method of manufacturing a fermented product includes the step of adding a food selected from the group of foods consisting of: seaweeds, micro-alga, and teff. The method may include the step of not adding non-food chemicals, non-natural chemicals, dairy, gluten, and GMO foods and wherein the fermented food product does not include the same.

The illustrated method of manufacturing a fermented product 10 includes the step of processing the paste according to a process selected from the group of processes consisting of drying and freezing 30. The method of manufacturing a fermented product includes the step of blending the paste with a fat 32.

According to one embodiment of the invention, there is a blended food product including fermented whole grain sweet rice sprouts, fermented whole grain quinoa sprouts, and fermented whole grain amaranth sprouts. The product does not include soy. The product does not include dairy and also does not include gluten. The product is dry and powdered. The product includes a fermented whole grain sprout selected from the group of whole grain sprouts including: barley, oats, millet, buckwheat, rye, teff, and kamut. The product includes water, sweetener, and fat. The food product includes between about 30% and about 70% sprouts. The rice sprouts, quinoa sprouts, and amaranth sprouts are present in substantially equal proportions.

According to one embodiment of the invention, there is a blended food product that includes fermented whole grain sweet rice sprouts; fermented whole grain quinoa sprouts; fermented whole grain amaranth sprouts. The blended food product includes a fermented whole grain sprout selected from the group of whole grain sprouts including: barley, oats, millet, buckwheat, rye, teff, and kamut; water; sweetener; and fat, while not including soy, not including gluten and not including dairy.

According to one embodiment of the invention, there is a method of manufacturing a fermented food product 10. The method 10 includes the step of providing a rinsed whole grain mixture 12 including whole grain sweet rice; whole grain quinoa; whole grain amaranth; a whole grain selected from the group of whole grains including: barley, oats, millet, buckwheat, rye, teff, and kamut; and not including soy, dairy and gluten.

The method of manufacturing a fermented product 10 includes the step of soaking the whole grain mixture until the whole grain mixture sprouts thereby forming a sprouted mixture 14. The sprouted mixture is also drained 16.

The method 10 includes the step of cooking the sprouted mixture thereby forming a cooked mixture 18. The method of manufacturing a fermented product 10 includes the step of fermenting the cooked mixture 22 using a starter culture 20. The method 10 also include the step of adding water and sweetener to the fermented cooked mixture 24. The method 10 includes the step of blending the fermented cooked mixture with a fat or oils 26. The method 10 further includes the step of adding a food selected from the group of foods consisting of: seaweeds, micro-alga, and teff. The method of manufacturing a fermented product 10 includes the step of converting the cooked mixture into a paste 30.

Glutinous rice or sweet rice is a type of rice grown mainly in Southeast and East Asia, which has opaque grains, very low amylose content, and is especially sticky when cooked. It is called glutinous in the sense of being glue-like or sticky, and not in the sense of containing gluten. While often called “sticky rice”, it differs from non-glutinous strains of japonica which also become sticky to some degree when cooked. There are numerous cultivars of glutinous rice, which include japonica, indica, and tropical japonica strains.

Glutinous rice is grown in Laos, Thailand, Cambodia, Vietnam, Malaysia, Indonesia, Myanmar, Bangladesh, Northeast India, China, Japan, Korea, Taiwan, and the Philippines. An estimated 85% of Lao rice production is of this type.

The improved rice varieties (in terms of yield) adopted throughout Asia during the Green Revolution were non-glutinous, and Lao farmers rejected them in favor of their traditional sticky varieties. Over time, higher-yield strains of glutinous rice have become available from the Lao National Rice Research Programme. By 1999, more than 70% of the area along the Mekong River Valley were of these newer strains.

Glutinous rice is distinguished from other types of rice by having no (or negligible amounts of) amylose, and high amounts of amylopectin (the two components of starch). Amylopectin is responsible for the sticky quality of glutinous rice. The difference has been traced to a single mutation that was selected for by farmers.

Like all types of rice, glutinous rice does not contain dietary gluten (i.e. does not contain glutenin and gliadin), and should be safe for gluten-free diets.

Glutinous rice can be used either milled or unmilled (that is, with the bran removed or not removed). Milled glutinous rice is white in color and fully opaque (unlike non-glutinous rice varieties, which are somewhat translucent when raw), whereas the bran can give unmilled glutinous rice a purple or black color. Black and purple glutinous rice are distinct strains from white glutinous rice. Both black and white glutinous rice can be cooked as discrete grains, or ground into flour and cooked as a paste or gel.

Quinoa, a species of goosefoot (Chenopodium), is a grain-like crop grown primarily for its edible seeds. It is a pseudo-cereal rather than a true cereal, or grain, as it is not a member of the true grass family. As a chenopod, quinoa is closely related to species such as beetroots, spinach and tumbleweeds.

Quinoa originated in the Andean region of Ecuador, Bolivia, Colombia and Peru, where it was successfully domesticated 3,000 to 4,000 years ago for human consumption, though archeological evidence shows a non-domesticated association with pastoral herding some 5,200 to 7,000 years ago.

The nutrient composition is very good compared with common cereals. Quinoa seeds contain essential amino acids like lysine and good quantities of calcium, phosphorus, and iron.

After harvest, the seeds need to be processed to remove the coating containing the bitter-tasting saponins. Quinoa leaves are also eaten as a leaf vegetable, much like amaranth, but the commercial availability of quinoa greens is limited.

Quinoa was important to the diet of pre-Columbian Andean civilizations. Today, people appreciate quinoa for its nutritional value. Quinoa has been called a superfood. Protein content is very high for a cereal/pseudo-cereal (14% by mass), yet not as high as most beans and legumes. Quinoa's protein content per 100 calories is higher than brown rice, potatoes, barley and millet, but is less than wild rice and oats. Nutritional evaluations of quinoa indicate that it is a source of complete protein. Furthermore, it is a good source of dietary fiber and phosphorus and is high inmagnesium and iron. Quinoa is also a source of calcium, and thus is useful for vegans and those who are lactose intolerant. Quinoa is gluten-free and considered easy to digest. Because of all these characteristics, quinoa is being considered a possible crop in NASA's Controlled Ecological Life Support System for long-duration human occupied spaceflights.

Quinoa may be germinated in its raw form to boost its nutritional value. Germination activates its natural enzymes and multiplies its vitamin content. In fact, quinoa has a notably short germination period: Only 2-4 hours resting in a glass of clean water is enough to make it sprout and release gases, as opposed to, e.g., 12 hours with wheat. This process, besides its nutritional enhancements, softens the seeds, making them suitable to be added to salads and other cold foods. There are various varieties/colors of quinoa.

Amaranthus, collectively known as amaranth, is a cosmopolitan genus of annual or short-lived perennial plants. Catkin-like cymes of densely packed flowers grow in summer or autumn. Approximately 60 species are recognized, with inflorescences and foliage ranging from purple and red to green or gold. Members of this genus share many characteristics and uses with members of the closely related genus Celosia.

Although several species are often considered weeds, people around the world value amaranths as leaf vegetables, cereals, and ornamental plants.

Cooked amaranth leaves are a good source of vitamin A, vitamin C, and folate; they are also a complementing source of other vitamins such as thiamine, niacin, and riboflavin, plus some dietary minerals including calcium, iron, potassium, zinc, copper, and manganese. Cooked amaranth grains are a complementing source of thiamine, niacin, riboflavin, and folate, and dietary minerals including calcium, iron, magnesium, phosphorus, zinc, copper, and manganese-comparable to common grains such as wheat germ, oats and others.

Amaranth seeds contain lysine, an essential amino acid, limited in other grains or plant sources. Most fruits and vegetables do not contain a complete set of amino acids, and thus different sources of protein must be used.

Amaranth may be a promising source of protein to those who are gluten sensitive, because unlike the protein found in grains such as wheat and rye, its protein does not contain gluten. According to a 2007 report, amaranth compares well in nutrient content with gluten-free vegetarian options such as buckwheat, corn, millet, wild rice, oats and quinoa.

Several studies have shown that like oats, amaranth seed or oil may be of benefit for those with hypertension and cardiovascular disease; regular consumption reduces blood pressure and cholesterol levels, while improving antioxidant status and some immune parameters. While the active ingredient in oats appears to be water-soluble fiber, amaranth appears to lower cholesterol via its content of plant stanols and squalene.

Amaranth remains an active area of scientific research for both human nutritional needs and foraging applications. Over 100 scientific studies suggest a somewhat conflicting picture on possible anti-nutritional and toxic factors in amaranth, more so in some particular strains of amaranth. Lehmann, in a review article, identifies some of these reported anti-nutritional factors in amaranth to be phenolics, saponins, tannins, phytic acid, oxalates, protease inhibitors, nitrates, polyphenols and phytohemagglutinins. There are various varieties/colors of amaranth.

Seaweed is a loose colloquial term encompassing macroscopic, multicellular, benthic marine algae. The term includes some members of the red, brown and green algae. Seaweeds can also be classified by use (as food, medicine, fertilizer, industrial, etc.). Like all algae, seaweeds are not plants.

Seaweeds are consumed by coastal people, particularly in East Asia, e.g., Brunei, Japan, China, Korea, Taiwan, Singapore, Thailand, Cambodia, and Vietnam, but also in South Africa, Indonesia, Malaysia, Belize, Peru, Chile, the Canadian Maritimes, Scandinavia, South West England, Ireland, Wales, California, Philippines, and Scotland.

In Asia, Nori (Japan), Zicai (China), and Gim (Korea) are sheets of dried Porphyra used in soups or to wrap sushi. Chondrus crispus (commonly known as Irish Moss or carrageenan moss) is another red alga used in producing various food additives, along with Kappaphycus and various gigartinoid seaweeds. Porphyra is a red alga used in Wales to make laver. Laverbread, made from oats and the laver, is a popular dish there. In northern Belize, edible seaweeds are mixed with milk, nutmeg, cinnamon, and vanilla to make a common beverage affectionately called “Dulce” (or “sweet”).

Seaweeds are also harvested or cultivated for the extraction of alginate, agar and carrageenan, gelatinous substances collectively known ashydrocolloids or phycocolloids. Hydrocolloids have attained commercial significance as food additives. The food industry exploits their gelling, water-retention, emulsifying and other physical properties. Agar is used in foods such as confectionery, meat and poultry products, desserts and beverages and moulded foods. Carrageenan is used in salad dressings and sauces, dietetic foods, and as a preservative in meat and fish products, dairy items and baked goods.

Microphytes or microalgae are microscopic algae, typically found in freshwater and marine systems. They are unicellular species which exist individually, or in chains or groups. Depending on the species, their sizes can range from a few micrometers (μm) to a few hundreds of micrometers. Unlike higher plants, microalgae do not have roots, stems and leaves. Microalgae, capable of performing photosynthesis, are important for life on earth; they produce approximately half of the atmospheric oxygen and use simultaneously the greenhouse gas carbon dioxide to grow photoautotrophically.

The biodiversity of microalgae is enormous and they represent an almost untapped resource. It has been estimated that about 200,000-800,000 species exist of which about 50,000 species are described. Over 15,000 novel compounds originating from algal biomass have been chemically determined. Most of these microalgae species produce unique products like carotenoids, antioxidants, fatty acids, enzymes, polymers, peptides, toxins and sterols.

The chemical composition of microalgae is not an intrinsic constant factor but varies over a wide range, both depending on species and on cultivation conditions. It is possible to accumulate the desired products in microalgae to a large extent by changing environmental factors like temperature, illumination, pH, CO₂ supply, salt and nutrients. Microalgae such as microphytes constitute the basic foodstuff for numerous aquaculture species, especially filtering bivalves.

They provide them with vitamins and polyunsaturated fatty acids, necessary for the growth of the bivalves which are unable to synthesize it themselves.

In addition, because the cells grow in aqueous suspension, they have more efficient access to water, CO₂, and other nutrients.

While fish oil has become famous for its omega-3 fatty acid content, fish don't actually produce omega-3s, instead accumulating their omega-3 reserves by consuming microalgae. These omega-3 fatty acids can be obtained in the human diet directly from the microalgae that produce them.

Teff, is an annual grass, a species of lovegrass native to the northern Ethiopian Highlands of East (Horn of) Africa. Common names include teff, lovegrass, annual bunch grass (English); Teff/Téff (Amharic, both representing the same sound, an ejective consonant); Taffi/xaffi (Oromo, both representing the same sound); Taff (Tigrinya); and mil éthiopien (French-‘Ethiopian millet’). It is also written as ttheff, tteff, thaff, tcheff, and thaft. The word “tef” is connected by folk etymology to the Ethio-Semitic root “tff”, which means “lost” (because of the small size of the grain).

Teff has been widely cultivated and used in the countries of Eritrea and Ethiopia. Teff accounts for about a quarter of total cereal production in Ethiopia. The grain can be used by celiacs (the gluten in teff does not contain the a-gliadin-fraction that causes a reaction in those with celiac disease) and has a high concentration of different nutrients, a very high calcium content, and significant levels of the minerals phosphorus, magnesium, aluminum, iron, copper, zinc, boron and barium, and also of thiamin. Teff is high in protein. It is considered to have an excellent amino acid composition, including all 8 essential amino acids for humans, and is higher in lysine than wheat or barley. Teff is high in carbohydrates and fiber. Teff is gaining popularity in the western United States as an alternative forage crop, in rotation with a legume such as alfalfa, because it uses C4 photosynthesis, similar to that of corn. It is noted for its high quality and high yield, when compared to other forage rotations. It is also known as an “emergency crop” because it is planted late in the spring when the growing season is warmer, and most other crops have already been planted. It does not tolerate any type of frost. Teff is also valued for its fine straw, which is traditionally mixed with mud for building purposes. There are various varieties/colors of teff.

Barley, a member of the grass family, is a major cereal grain. Important uses include use as animal fodder, as a source of fermentable material for beer and certain distilled beverages, and as a component of various health foods. It is used in soups and stews, and in barley bread of various cultures. Barley grains are commonly made into malt in a traditional and ancient method of preparation.

Barley contains eight essential amino acids. According to a 2006 study, eating whole-grain barley can regulate blood sugar (i.e. reduce blood glucose response to a meal) for up to 10 hours after consumption compared to white or even whole-grain wheat, which have similar glycemic indices. The effect was attributed to colonic fermentation of indigestible carbohydrates.

Hulled barley (or covered barley) is eaten after removing the inedible, fibrous, outer hull. Once removed, it is called dehulled barley (or pot barley or scotch barley). Considered a whole grain, dehulled barley still has its bran and germ, making it a nutritious and popular health food. Pearl barley (or pearled barley) is dehulled barley which has been steam processed further to remove the bran. It may be polished, a process known as “pearling”. Dehulled or pearl barley may be processed into a variety of barley products, including flour, flakes similar to oatmeal, and grits.

Barley meal, a whole meal barley flour lighter than wheat meal but darker in color, is used in porridge and gruel in Scotland. Barley meal gruel is known as sawiq in the Arab world. With a long history of cultivation in the Middle East, barley is used in a wide range of traditional Arabic, Assyrian, Israelite, Kurdish, and Persian foodstuffs including kashkak, kashk and murri. Barley soup is traditionally eaten during Ramadan in Saudi Arabia. Cholent or hamin (in Hebrew) is a traditional Jewish stew often eaten on Sabbath, in a variety of recipes by both Mizrachi and Ashkenazi Jews, with barley cited throughout the Hebrew Bible in multiple references. In Eastern and Central Europe, barley is also used in soups and stews such as ri\check{c}et. In Africa, where it is a traditional food plant, it has the potential to improve nutrition, boost food security, foster rural development and support sustainable land care.

The six-row variety bere is cultivated in Orkney, Shetland, Caithness and the Western Isles in the Scottish Highlands and islands. The grain is used to make beremeal, used locally in bread, biscuits, and the traditional beremeal bannock.

Like wheat and rye, barley contains gluten, which makes it an unsuitable grain for consumption by those with celiac disease.

Oats may mean either the common cereal oat discussed here, or any cultivated or wild species of the genus Avena.

The common oat (Avena sativa) is a species of cereal grain grown for its seed, which is known by the same name (usually in the plural, unlike other grains). While oats are suitable for human consumption as oatmeal and rolled oats, one of the most common uses is as livestock feed.

Oats have numerous uses in food; most commonly, they are rolled or crushed into oatmeal, or ground into fine oat flour. Oatmeal is chiefly eaten as porridge, but may also be used in a variety of baked goods, such as oatcakes, oatmeal cookies, and oat bread. Oats are also an ingredient in many cold cereals, in particular muesli and granola. Oats may also be consumed raw, and cookies with raw oats are becoming popular.

Historical attitudes towards oats have varied. Oat bread was first manufactured in Britain, where the first oat bread factory was established in 1899. In Scotland, they were, and still are, held in high esteem, as a mainstay of the national diet.

In Scotland, a dish called cow pat was made by soaking the husks from oats for a week, so the fine, floury part of the meal remained as sediment to be strained off, boiled and eaten. Oats are also widely used there as a thickener in soups, as barley or rice might be used in other countries.

Oats are also commonly used as feed for horses when extra carbohydrates, and the subsequent boost in energy, are required. The oat hull may be crushed (“rolled” or “crimped”) for the horse to more easily digest the grain, or may be fed whole. They may be given alone or as part of a blended food pellet. Cattle are also fed oats, either whole, or ground into a coarse flour using a roller mill, burr mill, or hammer mill.

Winter oats may be grown as an off-season groundcover and ploughed under in the spring as a green fertilizer, or harvested in early summer They also can be used for pasture; they can be grazed a while, then allowed to head out for grain production, or grazed continuously until other pastures are ready.

Oats are also occasionally used in several different drinks. In Britain, they are sometimes used for brewing beer. Oatmeal stout is one variety brewed using a percentage of oats for the wort. The more rarely used oat malt is produced by the Thomas Fawcett & Sons Maltings, and was used in the Maclay Oat Malt Stout before Maclays Brewery ceased independent brewing operations. A cold, sweet drink called avena made of ground oats and milk is a popular refreshment throughout Latin America. Oatmeal caudle, made of ale and oatmeal with spices, was a traditional British drink and a favourite of Oliver Cromwell.

The millets are a group of highly variable small-seeded grasses, widely grown around the world as cereal crops or grains for both human food and fodder. They do not form a taxonomic group, but rather a functional or agronomic one. Millets are important crops in the semi-arid tropics of Asia and Africa (especially in India, Nigeria, and Niger), with 97% of millet production in developing countries. The crop is favored due to its productivity and short growing season under dry, high temperature conditions.

The most widely grown millet is pearl millet, which is an important crop in India and parts of Africa. Finger millet, proso millet, and foxtail millet are also important crop species. In the developed world, millets are less important. For example, in the United States the only significant crop is proso millet, which is mostly grown for bird seed.

While millets are indigenous to many parts of the world, millets most likely had an evolutionary origin in tropical western Africa, as that is where the greatest number of both wild and cultivated forms exist. Millets have been important food staples in human history, particularly in Asia and Africa, and they have been in cultivation in East Asia for the last 10,000 years.

Millets are major food sources in arid and semiarid regions of the world, and feature in the traditional cuisine of many others. In western India, sorghum (called jowar, jwaarie or jondhahlaa in Gujarati, Hindi and Marathi languages, respectively, or mutthaari kora “pangapullu”in Malayalam), has been commonly used with millet flour (called bajari in western India) for hundreds of years to make the local staple, hand rolled (that is, without a rolling pin) flat bread (rotla in Gujarati or bhakri in Marathi or roti in other languages). Another cereal grain popularly used in rural areas and by poor people to consume as staple in the form of roti or other forms is called ragi in Karnataka or naachanie in Maharashtra or varagu in Tamil, with the popularly made ragi rotti in Kannada. Ragi mudde is a popular meal in southern India. In Telugu, it is called jonnalu (Jonnalu). Jonna is dark like rye, but rougher in texture.

Millet porridge is a traditional food in Russian, German and Chinese cuisines. In Russia, it is eaten sweet (with milk and sugar added at the end of the cooking process) or savoury with meat or vegetable stews. In China, it is eaten without milk or sugar, frequently with beans, sweet potato, and/or various types of squash. In Germany, it is also eaten sweet, boiled in water with apples added during the boiling process and honey added during the cooling process.

Per capita consumption of millets, as food, varies in different parts of the world. It is highest in western Africa. In the Sahel region, millet is estimated to account for about 35% of total cereal food consumption in Burkina Faso, Chad and the Gambia. In Mali and Senegal, millets constitute roughly 40 percent of total cereal food consumption per capita, while in Niger and arid Namibia it is over 65% (See Mahangu). Other countries in Africa where millets are a significant food source include Ethiopia, Nigeria and Uganda. Millet is also an important food item for the population living in the drier parts of many other countries, especially in eastern and central Africa, and in the northern coastal countries of western Africa. In developing countries outside Africa, millet has local significance as a food in parts of some countries, such as China, India, Burma and North Korea.

The use of millets as food has been falling on per capita basis, between the 1970s and the 2000s, both in urban and rural areas, as developing countries such as India have experienced rapid economic growth and witnessed a significant increase in per capita consumption of other cereals.

Millets, like sorghum, are predominantly starchy. The protein content is comparable to that of wheat and maize. Pearl and little millet are higher in fat, while finger millet contains the lowest fat. Barnyard millet has the lowest carbohydrate content and energy value. Millets are also relatively rich in iron and phosphorus. The bran layers of millets are good sources of B-complex vitamins. However, millets also feature high fiber content and poor digestibility of nutrients, which severely limit their value in nutrition and influence their consumer acceptability.

Finger millet has the highest calcium content among all the foodgrains, but it is not highly assimilable. The protein content in millet is very close to that of wheat; both provide about 11% protein by weight, on a dry matter basis.

Millets are rich in B vitamins (especially niacin, B₆ and folic acid), calcium, iron, potassium, magnesium, and zinc. Millets contain no gluten, so they are not suitable for raised bread. When combined with wheat (or xanthan gum for those who have celiac disease) they can be used for raised bread. Alone, they are suited for flatbread.

Buckwheat is a plant cultivated for its grain-like seeds, and also used as a cover crop. Despite the name, buckwheat is not related to wheat, as it is not a grass; instead, buckwheat is related to sorrel, knotweed, and rhubarb. The cultivation of buckwheat grain declined sharply in the 20th century with the adoption of nitrogen fertilizer that increased the productivity of other staples. A related species, Fagopyrum tataricum (Tartary buckwheat) is also cultivated as a grain in the Himalayas.

The fruit is an achene, similar to sunflower seed, with a single seed inside a hard outer hull. The starchy endosperm is white and makes up most or all of buckwheat flour. The seed coat is green or tan, which darkens buckwheat flour. The hull is dark brown or black, and some may be included in buckwheat flour as dark specks. The dark flour is known as blé noir (black wheat) in French, along with the name sarrasin (saracen).

Buckwheat noodles have been eaten by people from Tibet and northern China for a long time, as wheat cannot be grown in the mountain regions. A special press made of wood log was built to press the dough into hot boiling water when making buckwheat noodles. Old presses found in Tibet and Shansi share the same basic design features. The Japanese and Koreans might have learned the making of buckwheat noodles from them.

Buckwheat noodles play a major role in the cuisines of Japan (soba), Korea (naengmyeon, makguksu and memil guksu) and the Valtellina region of Northern Italy (pizzoccheri). Soba noodles are the subject of deep cultural importance in Japan. In Korea, guksu (noodles) were widely made from buckwheat before it was replaced by wheat. The difficulty of making noodles from flour with no gluten has resulted in a traditional art developed around their manufacture by hand.

Buckwheat groats are commonly used in western Asia and Eastern Europe. The porridge was common, and is often considered the definitive peasant dish. It is made from roasted groats that are cooked with broth to a texture similar to rice or bulgur. The dish was brought to America by Russian and Polish immigrants who called it kasha, and they mixed it with pasta or used it as a filling for knishes and blintzes, and hence buckwheat prepared in this fashion is most commonly called “kasha” in America, but the groats themselves are called “grechka” by Russian immigrants. Groats were the most widely used form of buckwheat worldwide during the 20th century, eaten primarily in Russia, Ukraine and Poland. The groats can also besprouted and then eaten raw or cooked.

Buckwheat pancakes, sometimes raised with yeast, are eaten in several countries. They are known as buckwheat blinis in Russia, galettes in France (savoury crêpes made with buckwheat flour, water and eggs are associated with Lower Brittany, whilst savoury galettes made without eggs are from Higher Brittany), ployes in Acadia and boûketes (which are named after the buckwheat plant) in the Wallonia region of Belgium. Similar pancakes were a common food in American pioneer days. They are light and foamy. The buckwheat flour gives them an earthy, mildly mushroom-like taste. In Ukraine, yeast rolls called hrechanyky are made from buckwheat. Buckwheat flour is also used to make Nepali dishes like “dhedo” and “kachhyamba”.

Rye is a grass grown extensively as a grain and as a forage crop. It is a member of the wheat tribe (Triticeae) and is closely related tobarley (Hordeum) and wheat (Triticum). Rye grain is used for flour, rye bread, rye beer, some whiskeys, some vodkas, and animal fodder. It can also be eaten whole, either as boiled rye berries, or by being rolled, similar to rolled oats.

Rye is a cereal grain and should not be confused with ryegrass, which is used for lawns, pasture, and hay for livestock.

Rye bread, including pumpernickel, is a widely eaten food in Northern and Eastern Europe. Rye is also used to make crisp bread. Rye flour is high in gliadin but low in glutenin. It therefore has a lower gluten content than wheat flour. It also contains a higher proportion of soluble fiber. Alkylresorcinols are phenolic lipids present in high amounts in the bran layer (e.g. pericarp, testa and aleurone layers) of wheat and rye (0.1-0.3% of dry weight).

Rye is used to make alcoholic drinks, like rye whiskey and rye beer. Other uses of rye include kvass and an alternative medicine known as rye extract. Rye straw is used to make corn dollies.

Khorasan wheat or Kamut is an ancient grain type; “Khorasan” refers to an historical region in modern-day Afghanistan and the northeast of Iran. This grain is twice the size of modern-day wheat and is known for its rich nutty flavor. Since 1990 KAMUT has been registered as a trademark by Kamut International, Ltd. with the United States Patent and Trademark Office for the wheat variety QK-77 of this species.

Khorasan wheat is sold in North America, Europe, Australia, and Asia. It can be found in products such as breads, breakfast cereals, pastas, a grain extract drink, beer, cookies, and crackers. The grain kernels can be milled into flour. The actual wheat grains can be soaked and used in salads. Even the wheatgrass can be harvested to be an ingredient in many different supplements.

The grain itself is very high in protein. It also contains a high mineral concentration especially in selenium, zinc, and magnesium. This grain variety is considered a high energy wheat, and provides the body with more energy in the form of complex carbohydrates. Because of its low oxidation levels it loses little nutritional content when being ground and processed. Even though this wheat variety contains gluten, it has been found to be more easily digestible by people who may have slight allergic tendencies.

The illustrated process includes steps of rinsing grains to remove undesired materials therefrom; soaking grains for the purpose of sprouting the grains thereby initiating enzymatic action and preparing the grains for a fermentations process; draining the grains to remove undesired fluids and material therein; cooking the grains to prepare and/or control the initial conditions of a fermentation process of the same; adding a starter culture to the grains to initiate a specific fermentation thereof; allowing the mixture to ferment; adding water and/or sweetener to the fermented mixture; blending the mixture with oils and/or fats; and cooling and/or drying the blended mixture. When completed, the process produces a blended grain food product (also called herein “synergistic food product”) having enhanced characteristics. Such a product may be hydrated to a desired consistency, may be milled/ground to a desired average particle size, may be frozen, shaped, baked, formed, flaked, formed into a powder, made into a mucilaginous paste, milled/formed into chips/cookies/biscuits/cubes/cakes/steaks/etc., salted, sweetened, made to be hard, soft, crunchy, pungent, bitter, sour, salty, and the like and combinations thereof.

In operation, the illustrated method of manufacture of blended whole grains is related to a fermentation process configured to mix and blend various whole grains into a base to create a synergistic food product. The synergistic food product is created by blending whole ingredients making a diversity of flavors, colors, textures, feels, shapes, and combinations of nutritional values. The synergistic food product is a complete gamut of naturally available nutrients, generally imparting many flavors, aromas, colors, textures, feels, shapes and nutritional values generally based solely on whole foods and nothing else, no ingredient enhancements, just whole/simple food ingredients synergistically combined through a controlled fermentation process.

The controlled fermentation process biochemically modifies the ingredients and their natural inherent properties and nutrients such as, but not limited to: protein, carbohydrates, vitamins, minerals, and fatty acids to be readily available and utilized by the body as energy/fuel, thereby saving energy otherwise used for the digestion thereof. The controlled fermentation process may include soaking, sprouting, cooking, and fermenting whole grains, pseudo-grains and/or ancient grains. These grains may serve as a base/blend. Such may be then presented in combination with other whole grain groups and/or other food products/ingredients.

A controlled fermentation process of whole grains may include natural anaerobic bacterial action LAB (Lactic Acid Bacteria) wherein their enzymes predigests the mixture/blend inherent nutrients by breaking them down from complex carbohydrates to simple sugars, from proteins to polypeptides and peptides and then into amino acids and complex fat molecules into free fatty acids thereby providing good intestinal flora, easy digestion assimilation plus improving nutritional value. The minerals, advantageously, become more readily available through soaking and sprouting, a hydrolysis process, from which the minerals are freed from the considered anti-nutrient, phytic acid. Rhysopus mold may be included (inherently or otherwise) as a part of the fermentation process.

A purpose of fermenting whole grains to make the base/blend plus the addition of different combinations of other ingredients may be to make a mixture/blend of whole ingredients to become a synergistic food product. This fermentative process generally creates product variety plus yields different combination of nutrients.

According to Steinkraus (1995), the traditional fermentation of foods serves several functions:
1. Enrichment of the diet through development of a diversity of flavors, aromas, and textures in food substrates
2. Preservation of substantial amounts of food through lactic acid, alcoholic, acetic acid, and alkaline fermentations
3. Enrichment of food substrates biologically with protein, essential amino acids, essential fatty acids, and vitamins
4. Detoxification during food fermentation processing
5. A decrease in cooking times and fuel requirements

A synergistic food product generally includes 1, 2, 3, 4, 5, 6, 7, 8, 9, 10, 11, or 12 whole grain ingredients or between about two or more of: 1, 2, 3, 4, 5, 6, 7, 8 , 9, 10, 11, 12 whole grain ingredients. Whole grain ingredients may include, but, unless otherwise specified in various embodiments, are not limited to: barley, oats, millet, buckwheat, rice, quinoa, rye, amaranth, teff, wheat, kamut, and corn. It may be that a synergistic food product does not include (specifically excludes) any of one or more of the following: soy, non-food chemicals, non-natural chemicals, artificial additives, artificial coloring, dairy, dairy derivatives, soy derivatives, gluten, gluten containing grains, and GMO foods and/or grains. It may be that a synergistic food product does not include any grains that are not whole grains. Whole grains and/or a fermented whole grain blend may be blended with or otherwise include legumes, such as but not limited to: beans, peas, and lentils. Whole grains and/or a fermented whole grain blend may be blended with other ingredients of non-cereal nature.

Whole grains and/or a fermented whole grain blend may be blended with at least a combination with other food ingredients, including but not limited to: raw, fresh, germinated, dried, dehydrated, sprouted, fermented and/or cooked foods, such as: fruits, vegetables, roots and tubers and bulbs, shoots and stalks, legumes, spices, herbs, oils, fats, nuts, seeds, seaweeds, micro-algae, fungi or mushrooms, or any combination thereof. Whole grains and/or a fermented whole grain blend may be blended together to form various textures such as but not limited to: chewy, granular, soft and crispy including various flavors, such as but not limited to: sweet, sour, bitter, salty, pungent, etc. Whole grains and/or a fermented whole grain blend may be consumed at room temperature, hot, cold, or frozen. A blend may be reconstituted and/or hydrated with water and/or other liquids, including but not limited to raw and/or cooked milks (nut, animal, etc.), juices (fruits, vegetables, etc.), syrups (fruit, vegetable, tree saps, etc.), etc.

According to one embodiment of the invention, a fermented whole grain blend food product may include a combination of about: 12.5% of sweet rice, 12.5% quinoa, 12.5% of amaranth, 12.5% teff, 4.817% sweetener, 3.440% oil/fat, and about 41% water (or an amount of water sufficient to complete the combination). Percentages described above may vary between about two or more of: 0.5, 1.0, 1.5, 2.0, 2.5, 5.0, 7.5, 10.0, 12.5, 15.0, and 20.0%. The resulting synergistic food product may include, as a non-limiting example, 11.73% protein, 2.49% mineral content, 0.87% fatty acids, and 76.07% carbohydrates. The resulting synergistic food product may inherently include and/or be combined with natural vitamins such as but not limited to: vitamin B, and minerals like calcium, magnesium, phosphorous, potassium, etc. The synergistic food product may inherently include and/or may be combined with prebiotics and probiotics, such as lactic acid, and other healthy microorganisms through the fermentation process. A fermentation process may advantageously allow proliferation of naturally occurring prebiotics and probiotics, such as but not limited to lactic acid and/or healthy microorganisms.

The resulting synergistic food product may be combined with a natural sweetener, such as but not limited to: unrefined cane sugar, fruit sweeteners, palm sugar, or coconut syrup, stevia, maple sugar or syrup, dates, rice syrup, honey, agave or chicory root inulin or in a syrup form, monk fruit, or any combination thereof. The synergistic food product is combined with natural oils and fats, such as but not limited to: unprocessed sources of essential fatty acids, saturated, monounsaturated, cold pressed, unrefined cooking oils and fats, such as but not limited to olive, canola, corn, vegetable, palm, nut, seed, coconut, and avocado oils and the like and combinations thereof and nut butters and the like and combinations thereof.

According to one embodiment of the invention, there is a method of manufacture for blending whole grains that may include the steps of soaking the grains, germinating the grains, cooking the grains, fermenting the grains with a mixture that may include a sweetener and oil, and then blending the whole mixture into a paste.

In one non-limiting embodiment, a synergistic food product includes only whole quality ingredients, has a myriad of great flavors and many textures plus a long shelf life with the advantage of resisting high and low temperatures as a finished product. And through a fermentative process the nutrients are readily available to be absorbed by the body.

In one non-limiting embodiment, a synergistic food product yields many variations in dry form, it may have many shapes and textures depending on the ingredients used. It satisfies our natural cravings with natural whole ingredients. The base product itself as described herein contains 6 ingredients; variations to the base could increase or decrease the number of ingredients in the finished product.

A synergistic food product may be a replacement of soy protein bars and nut/fruit bars without the infinite number of ingredients spelled in the label, or any added vitamins or added minerals, fibers and so many other added preservatives and derivatives that it is impossible to know what one is eating and being very hard for a digestive system to absorb the nutrients right away.

A fermentative process may create a base/blend by mixing/processing whole grains. A part of the fermentation and/or blending/mixing process involves the addition of other wholesome ingredients including, but not limited to: raw/fresh, germinated/sprouted, cooked and fermented foods: fruits and vegetables, roots, tubers and bulbs, shoots and stalks, legumes, mushrooms/fungi, spices, herbs, oils, fats, nuts, seeds, seaweeds, micro-algae or combinations thereof configured to provide the mixture/blend additional qualities, beneficial properties and varied healthy nutrients.

Additional ingredients may be added after the base/blend has been fermented or the added ingredients may also or not be fermented within the mixture/blend. Additionally the fermentation process enhances taste, texture, natural flavors and long shelf life. The main ingredient to make the base/blend are whole grains and etc. as described herein, the rest are water, sweetener and oil/fat in small amounts.

According to one embodiment of the invention, there is a method of manufacture of fermented whole grain blends comprising the step of thoroughly rinsing the whole grains. The method includes the step of letting the grains soak for about twelve hours in water. Then the water from the soaked grains is drained. During this step the grains may or may not be rinsed and such may substantially alter one or more characteristics of the final product. The method also includes the step of cooking the grains together in water at about one hundred degrees Fahrenheit (or more, may be between about two of 100, 105, and 350 degrees Fahrenheit). The method includes the step of inoculating the grains with starter culture after cooking (such may be performed at temperatures between about two of about 0, 32, 60, 90, 98, 100, and 105 degrees Fahrenheit or higher), such as but not limited to when the cooking grains reach body temperature. Then, the grains are left for another period of time (generally about twelve hours) to initiate the fermentation. During such a step, generally nothing else is added. The method may include a step of adding warm water (close to or higher than body temperature) and/or a sweetener to the grains and then being left for another period of time (generally about twelve hours and such may be performed at temperatures between about two of about 0, 32, 60, 90, 98, 100, and 105 degrees Fahrenheit or higher),). The method includes the step of blending the grains to form a slurry/paste adding more water with oil/fat. The method includes refrigerating, freezing, and/or drying the resultant material.

In one non-limiting embodiment, there is a fermented food product blend that includes only whole grain: teff, sweet rice, amaranth and quinoa along with only rice syrup and coconut oil (other than ingredients like starter culture and water used in the formation thereof and materials generated during the manufacturing process). In another non-limiting example, teff is not included. Lactic acid bacteria and/or Rhizopus mold may be utilized (inherently present or otherwise) in the fermentation thereof. Soaking during the manufacturing process may be tuned to help beneficial sprouting of the whole grains included therein. Such a blend may include ingredients in about the amounts of approximately equal amounts of each grain by weight, sweetener and oil in approximately equal amounts and water to a desired consistency.

In one non-limiting embodiment, the illustrated method of manufacture of blended whole grains/pseudo-grains and/or ancient grains is related to a fermentation process configured to mix and blend various whole ingredients to create a synergistic food product. The synergistic food product consists of a base which can be used or eaten plain or can be mixed with countless/innumerable combinations with other whole grain groups and non-whole grains groups and many other ingredients making a diversity of flavors, colors, textures, feels, shapes, etc., thus resulting in varied and naturally occurring combinations of nutritional values based solely on whole/simple foods and nothing else; no ingredient enhancements, only synergistically combined wholesome food ingredients. The complete gamut of the product's inherent nutrients such as, but not limited to: protein, carbohydrates, vitamins, minerals and oils/fats are broken down into simple digestive forms to be readily available and utilized by the body as energy/fuel, thereby saving energy otherwise used for digestion. This blending process includes controlled soaking, controlled sprouting, temperature controlled cooking, and controlled fermenting whole grains/pseudo-grains and ancient grains.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of manufacturing a fermented food product, comprising the steps of:
a) providing a rinsed whole grain mixture including whole grain sweet rice, whole grain quinoa, whole grain amaranth, and not including soy;
b) cooking the whole grain mixture thereby forming a cooked mixture;
c) fermenting the cooked mixture using a starter culture; and
d) converting the cooked mixture into a paste.

2. The method of claim 1, further comprising the step of soaking at least one of the included grain types of the whole grain mixture and sprouting the same before cooking the whole grain mixture.

3. The method of claim 1, further comprising the step of adding water and sweetener to the fermented cooked mixture.

4. The method of claim 1, further comprising blending the fermented cooked mixture with oils and fats.

5. The method of claim 4, further comprising cooling or draining the blended grain mixture.

6. The method of claim 1, further comprising adding a food selected from the group of foods consisting of: seaweeds, micro-alga, and teff.

7. The method of claim 1, wherein the steps include not adding non-food chemicals, non-natural chemicals, dairy, gluten, and GMO foods and wherein the fermented food product does not include the same.

8. The method of claim 1, further comprising processing the paste according to a process selected from the group of processes consisting of drying and freezing.

9. The method of claim 1, further comprising blending the paste with a fat.

10. The method of claim 1, wherein the rinsed whole grain mixture further includes a whole grain selected from the group of whole grains including: barley, oats, millet, buckwheat, rye, teff, and kamut

11. A blended food product comprising fermented whole grain sweet rice, fermented whole grain quinoa, and fermented whole grain amaranth.

12. The product of claim 11, not including soy and wherein at least one of the grain types included is a sprout thereof.

13. The product of claim 11, not including dairy and not including gluten.

14. The product of claim 11, wherein the product is dry and powdered.

15. The product of claim 11, further including a fermented whole grain sprout selected from the group of whole grain sprouts including: barley, oats, millet, buckwheat, rye, teff, and kamut.

16. The product of claim 11, further comprising water, sweetener, and fat.

17. The product of claim 11, wherein the food product includes between about 30% and about 70% sprouts.

18. The product of claim 11, wherein the rice sprouts, quinoa sprouts, and amaranth sprouts are present in substantially equal proportions.

19. A blended food product comprising fermented whole grain sweet rice sprouts; fermented whole grain quinoa sprouts; fermented whole grain amaranth sprouts; a fermented whole grain sprout selected from the group of whole grain sprouts including: barley, oats, millet, buckwheat, rye, teff, and kamut; water; sweetener; and fat, while not including soy, not including gluten and not including dairy.

20. A method of manufacturing a fermented food product, comprising the steps of:
a) providing a rinsed whole grain mixture including whole grain sweet rice; whole grain quinoa; whole grain amaranth; a whole grain selected from the group of whole grains including: barley, oats, millet, buckwheat, rye, teff, and kamut; and not including soy, dairy and gluten;
b) soaking the whole grain mixture until the whole grain mixture sprouts thereby forming a sprouted mixture;
c) cooking the sprouted mixture thereby forming a cooked mixture;
d) fermenting the cooked mixture using a starter culture;
e) adding water and sweetener to the fermented cooked mixture;
f) blending the fermented cooked mixture with a fat;
g) adding a food selected from the group of foods consisting of: seaweeds, micro-alga, and teff; and
h) converting the cooked mixture into a paste.
